(19) United States
(12) Patent Application Publication
(10) Pub. No.: US 2024/0220720 A1
(43) Pub. Date: Jul. 4, 2024

(54) RECORDING AND ORGANIZING PROGRAM, RECORDING AND ORGANIZING METHOD, RECORDING AND ORGANIZING DEVICE, AND RECORDING MEDIUM

(71) Applicant: AQUIAPLANET CORPORATION, Nerima-ku, Tokyo (JP)

(72) Inventor: Akira OSHIRO, Nerima-ku, Tokyo (JP)

(73) Assignee: AQUIAPLANET CORPORATION, Nerima-ku, Tokyo (JP)

(21) Appl. No.: 18/563,403

(22) PCT Filed: Oct. 20, 2021
(86) PCT No.: PCT/JP2021/038842

§ 371 Date: Nov. 22, 2023

(30) Foreign Application Priority Data
May 27, 2021 (JP) 2021-089657

(51) Int. Cl. G06F 40/247; G06F 16/22; G06F 16/28; G06F 40/242

(52) U.S. Cl. CPC G06F 40/247; G06F 16/2246; G06F 16/282; G06F 40/242

(57) ABSTRACT

People's statements are not always grammatically correct. The subjects thereof are not specified since they are expressed by pronouns, or are omitted in Japanese and the like. Therefore, the record of speech and the like in unchanged form is incorrect as information, and in many cases, it is difficult to utilize the record in unchanged form. A method for structuring and recording an inputted item comprises: an input step for inputting a user's statement by an input unit; a structuring step for, in a structuring unit, creating a structured record in which the user's statement inputted in the input step is applied to a predetermined structure, and storing the structured record in a recording unit; and a presentation step for presenting, to the user, at least part of the structured record by a presentation unit, the structure having a tree structure composed of a plurality of hierarchies.

### TECHNICAL FIELD

The present invention relates to a recording and organizing program, a recording and organizing method, a recording and organizing device, and a recording medium.

### BACKGROUND TECHNOLOGY

A method of recording voice, etc. is known.

Compared to inputting and recording using your hands using a writing instrument or keyboard, there is no need to move in front of the device or take the device out of your bag, so you can interrupt your work without stopping your current task. You can proceed smoothly without any hassle.

Patent Document 1 describes a search system that searches for documents based on input information. Further, Patent Document 2 describes an interactive creative activity support device and its program.

### PRIOR ART DOCUMENTS

### Patent Document

[Patent Document 1] Japanese Patent Application Publication No. 2003-223461
[Patent Document 2] Japanese Patent Application No. 2019-214996

### SUMMARY OF THE INVENTION

### Problem to be Solved by the Invention

However, what people say is not always grammatically correct, and the subject is often substituted with a pronoun and not explicitly stated, or in Japanese, the subject is often omitted.

For this reason, simply recording voice etc. as it is, is inaccurate as information, and it is often difficult to utilize it as is.

Therefore, an object of the present invention is to provide a recording and organizing program, a recording and organizing method, and a recording and organizing device that organize and record voice records and the like as accurate information.

In addition, when considering desired materials, conducting creative activities such as research and development, inventions, and performing diagnosis, it is required to obtain information not only once, but also repeatedly for considering the activities. The more complicated work and time it takes to repeatedly obtain information, the more likely it is that discussions or diagnoses are interrupted, causing problems such as forgetting the items or ideas being considered, or interrupting conversations with patients. As a result, research and development and diagnostics often go awry.

For example, entering information one wants to obtain using a terminal, or reading and comparing the obtained information can also be a factor in interrupting your study. In actual R&D and diagnostic work, it is necessary to consider ideas and information that arise while working or diagnosing away from the terminal without stopping the work or diagnosis.

Although Patent Document 1 describes a search system, it requires inputting via a terminal each time and reading the search results. Note that paragraph 0024 of Patent Document 1 also mentions voice, but only states that “input may be performed by voice.”

Therefore, an object of the present invention it to provide a recording and organizing program, a recording and organizing method, and a recording and organizing device that are more suitable for R&D, diagnosis, and other sites, by enabling creative activities such as R&D and diagnosis, to be carried out smoothly by repeatedly obtaining the desired information without requiring complicated work or troublesome time.

### Means to Solve the Problem

A recording and organizing method according to claim 1 of the present invention is,
the recording and organizing method configured to structure and record an input item comprises:
an input step configured to input a user's comment through an input unit,
a structuring step configured to
   make, in a structuring unit, a structured record by applying the user's comment input in the input step to a predetermined structure and
   store the structured record in a recording unit, and,
a presentation step configured to present, to the user, at least a part of the structured record by a presentation unit, wherein
the structure has a tree structure composed of a plurality of hierarchies.

A recording and organizing method according to claim 2 of the present invention is the recording and organizing method according to claim 1, wherein in the input step, text is input instead of the user's comment.

The recording and organizing method also includes inputting both text and voice.

A recording and organizing method according to claim 3 of the present invention is the recording and organizing method according to any one of claim 1 and claim 2, wherein in the structuring step, the record is divided into time record and non-time record.

A recording and organizing method according to claim 4 of the present invention is the recording and organizing method according to any one of claims 1 to 3, wherein the input step and/or the structuring step includes a user discrimination step.

A recording and organizing method according to claim 5 of the present invention is the recording and organizing method according to any one of claims 1 to 4, further comprising an interpersonal appropriateness step after the user discrimination step.

A recording and organizing method according to claim 6 of the present invention is the recording and organizing method according to any one of claims 1 to 5, further comprising a confirmation step of accepting corrections after the presentation step.

A recording and organizing method according to claim 7 of the present invention is,
the recording and organizing method according to any one of claims 1 to 6, further comprising a
a comparing step configured to create a comparison result by comparing the structured record with reference to other information, after the structuring step, wherein
in the presentation step, at least a part of the comparison results is configured to be presented.

A recording and organizing method according to claim 8 of the present invention is,
the recording and organizing method according to any one of claims 1 to 7, wherein the comparing step comparing:
   a searching step configured to search for information regarding the structured record, and
a search result recording step configured to record a search result information, the search result is a search result.

A recording and organizing method according to claim 9 of the present invention is,
the recording and organizing method according to claim 8, wherein the comparing step further comprises the structuring step after the search result recording step to structure the search result information.

A recording and organizing method according to claim 10 of the present invention is,
the recording and organizing method according to claim 8, comprising, after the search result recording step:
   a higher order extraction step configured to extract a part of the search result information, and,
   the structuring step to structure the search result information.

A recording and organizing method according to claim 11 of the present invention is,
the recording and organizing method according to claim 8, wherein the comparison result includes a difference between the structured record and the other information.

A recording and organizing method according to claim 12 of the present invention is,
the recording and organizing method according to any one of claims 1 to 11, wherein the comparison result includes the superiority and inferiority of concepts by referring to concept data indicating the relationship between superiority and inferiority of concepts.

A recording and organizing method according to claim 13 of the present invention is,
the recording and organizing method according to claim 1, further comprising a dictionary reference step configured to refer to synonyms.

It is possible to save multiple words as synonyms and show accurate information and comparison results based on the synonym information.

A recording and organizing method according to claim 14 of the present invention is,
the recording and organizing method according to claim 13, further comprising a dictionary storing a synonym for each user or for each field.

A recording and organizing method according to claim 15 of the present invention is
the recording and organizing method according to claim 14, further comprising a synonym modification step configured to modify the synonym based on input from the user.

With feedback from users, synonym information can be made more accurate and more accurate comparison results can be shown to the user.

A recording and organizing method according to claim 16 of the present invention is
the recording and organizing method according to any one of claims 1 to 15, characterized in that the presentation is performed by a method other than audio or textual information through the movement of the movement unit.

In addition to the movement of the movement unit, the recording and organizing method also includes presenting by audio voice or text information.

A recording and organizing device according to claim 17 of the present invention is,
the recording and organizing device comprising the input unit, the structuring unit, the recording unit, and the presentation unit, and configured to execute each step according to any one of claims 1 to 15.

A recording and organizing device according to claim 18 of the present invention is,
the recording and organizing device comprising the movement unit and being configured to execute each step according to claim 16.

A recording and organizing program according to claim 19 of the present invention is,
the recording and organizing program configured to make the input unit, the structuring unit, the recording unit, and the presentation unit to function as each unit of the recording and organization device according to claim 17.

A recording and organizing program according to claim 20 of the present invention is,
the recording and organizing program configured to make the input unit, the structuring unit, the recording unit, the presentation unit, and the operation unit to function as each unit of the recording and organization device according to claim 18.

A recording medium according to claim 21 of the present invention is,
the recording medium on which the recording and organizing program according to claim 19 or 20 is recorded.

### Effect of the Invention

The present invention provides a recording and organizing program, a recording and organizing method, and a recording and organizing device that organize and record voice records and the like as accurate information.

In addition, the present invention enables creative activities such as research and development, diagnosis, etc. to be carried out smoothly by repeatedly obtaining desired information without requiring complicated work or bothersome time, and the present invention provides a recording and organizing program, a recording and organizing method, and a recording and organizing device that are more suited to the field of R&D, diagnosis, etc.

### BRIEF EXPLANATION OF DRAWINGS

FIG. 1 shows an example of a recording and organizing method in an embodiment of the present invention.

FIG. 2 shows an example of a conceptual structure in an embodiment of the present invention.

FIG. 3 shows an example of a configuration of a recording and organizing device in an embodiment of the present invention.

FIG. 4 shows an example of a conceptual structure in an embodiment of the present invention.

FIG. 5 shows an example of a conceptual structure in an embodiment of the present invention.

FIG. 6 shows an example of a recording and organizing method in an embodiment of the present invention.

FIG. 7 shows an example of a recording and organizing method in an embodiment of the present invention.

FIG. 8 shows an example of a recording and organizing method in an embodiment of the present invention.

FIG. 9 shows an example of a recording and organizing method in an embodiment of the present invention.

FIG. 10 shows an example of a recording and organizing method in an embodiment of the present invention.

FIG. 11 shows an example of a recording and organizing method in an embodiment of the present invention.

FIG. 12 shows a configuration example of a recording and organizing device in an embodiment of the present invention.

FIG. 13 shows an example of a recording and organizing method in an embodiment of the present invention.

FIG. 14 shows an example of a recording and organizing method in an embodiment of the present invention.

FIG. 15 shows an example of a configuration of a recording and organizing device in an embodiment of the present invention.

FIG. 16 shows an example of a conceptual structure in an embodiment of the present invention.

FIG. 17 shows an example of a conceptual structure in an embodiment of the present invention.

FIG. 18 shows an example of a conceptual structure in an embodiment of the present invention.

FIG. 19 shows an example of a recording and organizing method in an embodiment of the present invention.

FIG. 20 shows an example of a configuration of a dictionary in an embodiment of the present invention.

FIG. 21 shows an example of a configuration of a dictionary in an embodiment of the present invention.

FIG. 22 shows an example of the configuration of a dictionary in an embodiment of the present invention.

FIG. 23 shows an example of a recording and organizing method in an embodiment of the present invention.

FIG. 24 shows an example of a conceptual structure in an embodiment of the present invention.

FIG. 25 shows the configuration of a recording and organizing device in an embodiment of the present invention.

FIG. 26 shows an example of the movement of the movement unit of the recording and organizing device in one embodiment of the present invention.

FIG. 27 shows an example of the movement of the movement unit of the recording and organizing device in one embodiment of the present invention.

FIG. 28 shows an example of the movement of the movement unit of the recording and organizing device in one embodiment of the present invention.

FIG. 29 shows an example of the movement of the movement unit of the recording and organizing device in one embodiment of the present invention.

FIG. 30 shows a recording and organizing program in an embodiment of the present invention.

### FORM FOR CARRYING OUT THE INVENTION

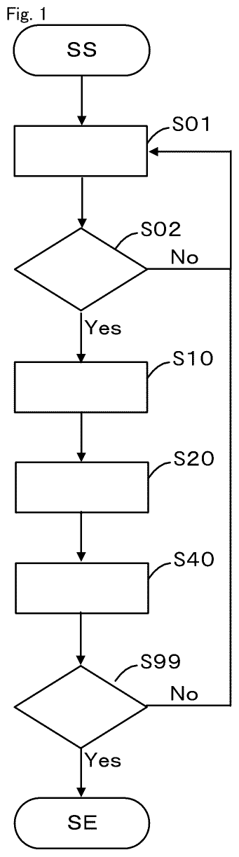

FIG. 1 shows a recording and organizing method in an embodiment of the present invention.

The recording and organizing method is a method of structuring and recording input items, and includes an input step (S10), a structuring step (S20), and a presentation step (S40).

First, when record organization is started (SS), the process advances to a standby step (S01) for waiting for input. If the input cannot be confirmed in the input determination step (S02) of confirming the presence or absence of input, the process returns to the standby step (S01). If the input is confirmed, the process advances to input step (S10).

In the input step (S10), the user's comment is input through the input unit 10.

In the structuring step (S20), the structuring unit 20 creates a structured record in which the user's comment which is input in the input step (S10) is applied to a predetermined structure, and the structured record is stored in the recording unit. Here, the control unit 60 functions as the recording unit.

In the presentation step (S40), the presentation unit 40 presents at least a part of the structured record to the user.

After the presentation step (S40) is completed, the process proceeds to a step for instructing the end of record organization (S99), and the record organization is ended (SE) if the end of record organization is instructed, while the process returns to the standby step (S01) if no instruction is given.

If the user states a more specific configuration or a different configuration for the presented results, or in other words, if the user proceeds with further consideration based on the feedback received from the device, the series of methods from the input step (S10) described above will start just by verbally inputting the resulting information into the device again, and the user can repeatedly obtain the information she or he wants without tedious work or time, such that, creative activities such as research, development and diagnosis can be carried out smoothly, and records can be organized in a way that is more in line with the actual research, development and diagnosis sites where considerations are repeated.

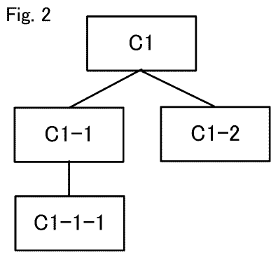

As shown in FIG. 2, the structure has a tree structure composed of a plurality of hierarchies or multiple layers. Under a concept C1, there are a concept C1-1 and a concept C1-2, and under the concept C1-1 there is a concept C1-1-1. In this invention, a configuration, in which a plurality of concepts are arranged branching from the highest concept to the lowest concept, is referred to as a tree structure.

Concepts (C) in the tree structure indicate limitations on properties such as date and time, location, color, length, and movement, as well as ownership.

For example, in the case of date and time, the order of the concepts is, from the top concept to the bottom concept, year, month, day, hour, minute, etc. A hierarchy of quarters may be provided as a concept under the year, a hierarchy of early, middle, and late periods may be provided as a concept under the month, and a hierarchy of morning and afternoon may be provided as a concept under the date. Dates and times are usually stated in order from the top concept to the bottom concept, such as month, day, hour, minute, etc., so a tree structure can be constructed in the order of input.

In one of the simplest example, the tree structure may be composed of combinations of nouns. In other words, in a case of a car, for example, where “aluminum-bodied car” is input, a tree structure can be provisionally constructed in which concept C1-1-1 is “aluminum,” concept C1-1 is “vehicle body,” and concept C1 is “automobile,” according to the normal Japanese order, only by simply extracting nouns in the input without performing advanced parsing.

In this example, if the input is not grammatically correct, such as “It's a car, but the body is aluminum,” normal parsing will not be able to accurately parse it, and structured information will often not be constructed. Even in the simplest example described above, the concept C1-1-1 will be “automobile,” the concept C1-1 will be “vehicle body,” and the concept C1 will be “aluminum,” resulting in inaccurate structured information. However, if a step of modifying structured information, which will be described later, is also used, the structured information can be corrected based on feedback from the user, and structuring becomes easier and more accurate.

It goes without saying that if normal syntax analysis is used, it will be easier to create a structure that includes the relationship between higher and lower levels of concepts.

In this way, by using structured information using a tree structure, it is possible to construct structured information with a certain degree of accuracy even with a simple verbalization method that extracts only nouns, and it is possible to construct structured information with a certain degree of accuracy by using a simple verbalization method that extracts only nouns. By using this method, structured information with even higher precision can be constructed.

Furthermore, even if sophisticated verbalization methods are used, correct language processing is often not possible because human comment are not always grammatically correct and subjects are often omitted. However, if the information is structured using a tree structure as in this embodiment, accurate structuring becomes possible through a confirmation step, interpersonal appropriateness, a dictionary, etc., which will be described later.

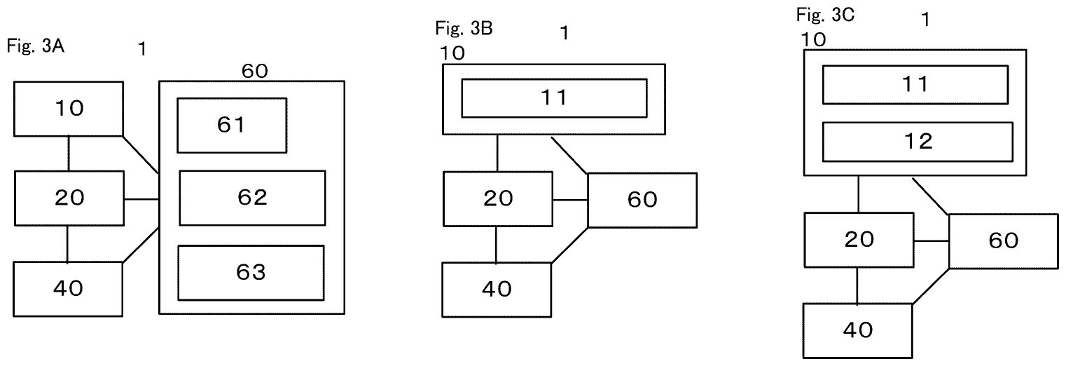

FIG. 3 shows a recording and organizing device. The recording and organizing device 1 includes an input unit 10, a structuring unit 20, and a presentation unit 40, each of which is further connected to a control unit 60.

The input unit 10 inputs the user's comments. The input user's comment becomes a structured record in the structuring unit 20, and the record is stored in the control unit 60 functioning as a recording unit.

As shown in FIG. 3A, the control unit 60 includes a CPU 61, a program storage area 62, and a data storage area 63. In the program storage area 62, a recording and organizing program that controls the operation of each part is recorded. Further, each data such as user's comments and structured records is recorded in the data storage area 63. The CPU 61 controls each unit, such as the input unit 10, the structuring unit 20, and the presentation unit 40, by executing a recording and organizing program recorded in the program storage area 62.

The program storage area 62 and the data storage area 63 can be configured with, for example, a hard disk or a flash memory. It goes without saying that, it is not necessary to store all programs and data in the program storage area 62 and data storage area 63 themselves, and such configurations are also included where the program storage area 62 and/or data storage area 63 refer to programs and data stored externally through communication devices, and the like.

At least a part of the stored structured record is presented to the user by the presentation unit 40.

As described above, the recording and organizing device is a deice configured to structure and record an input item, and the device has an input unit configured to input a user's comment to the recording and organizing device, a structuring device configured to make a structured record by applying the user's comment input by the input unit to a predetermined structure and configured to store the structured record in a recording unit, and, a presentation unit configured to present, to the user, at least a part of the structured record by the presentation unit, wherein the structure has a tree structure composed of a plurality of hierarchies.

In one embodiment, in the input step (S10), text can be input instead of the user's comment. In this case, the input step (S10) may be performed by scanning or reading from an image.

The recording and organizing device in this embodiment is the recording and organizing device mentioned above, having a input unit configured to input text instead of the user's comment.

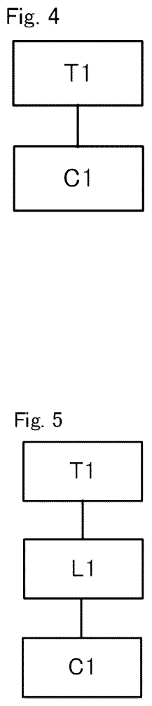

FIGS. 4 and 5 show a structure in one embodiment of the present invention.

In this embodiment, in the structuring step (S20), the structured record is divided into time (T1) and non-time (C1). The time may be extracted from the input data or may be actual time when the user input the data.

The recording and organizing device in this embodiment is any one of the recording and organizing devices described above, wherein the structuring unit performs structuring by dividing the input data into time and non-time. Everything except the time can be left as it is in the original text, as long as it fits the purpose of this invention. Time can be present, future, or past time. Alternatively, the location (L1) may be used instead of the time (T1).

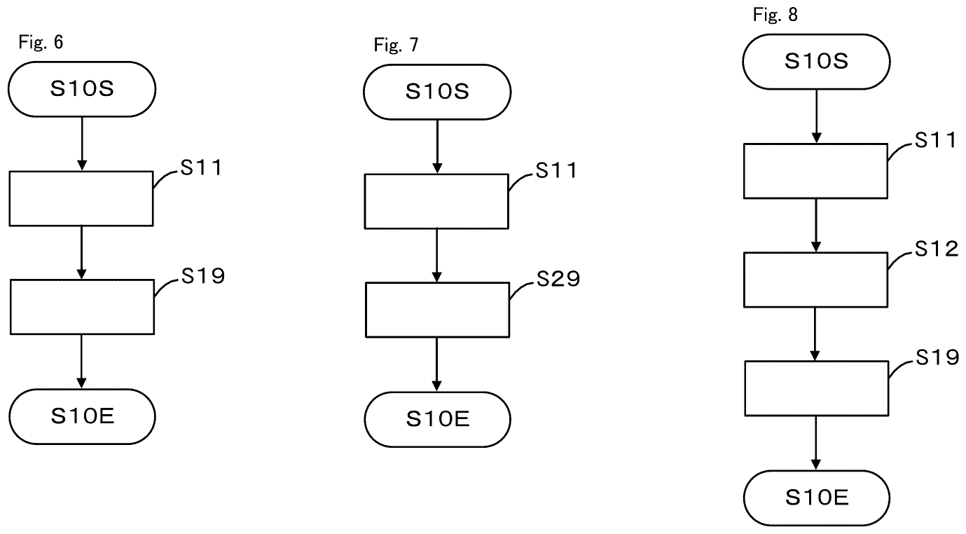

FIGS. 6 and 7 show the input step (S10) and the structuring step (S20) of the recording and organizing method in an embodiment of the present invention. In this embodiment, the input step (S10) and/or the structuring step (S20) includes a user discrimination step (S11). That is, as shown in FIG. 6, when the input step (S10) is started (S10S), the process first proceeds to the user discrimination step (S11), and then input is performed in the input execution step (S19), and the input step (S10) ends (S10E). Alternatively, as shown in FIG. 7, when the structuring step (S20) is started (S10S), the process first proceeds to the user identification step (S11), and then structuring is performed in the structuring execution step (S29), the structuring step (S20) may be completed (S10E).

In the user discrimination step (S11), the user is discriminated, and furthermore, in the case of an unregistered user, data of the most similar user among registered users can be used.

When identifying a user, in addition to voice prints, it is also possible to use multiple factors such as name confirmation, voice pitch, speaking speed, characteristic terms, and other factors.

As shown in FIG. 3B, the input unit 1 includes the user discrimination unit 11, but it goes without saying that the user discrimination unit 11 may be provided in a place other than the input unit 11.

The recording and organizing device in this embodiment is any of the above-mentioned recording and organizing devices, wherein the input unit or the structuring unit includes a user determination unit.

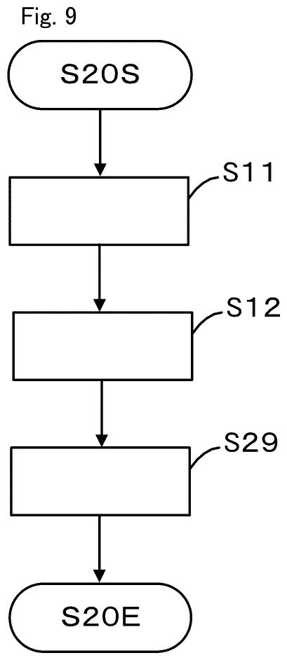

FIGS. 8 and 9 show a recording and organizing method in an embodiment of the present invention.

In this embodiment, an interpersonal appropriateness adjustment step (S12) is provided after the user determination step (S11). That is, as shown in FIG. 8, when the input step (S10) is started (S10S), the process first proceeds to the user discrimination step (S11), then the interpersonal appropriateness step (S12), and finally input is performed in the input implementation step (S19), and input step (S10) ends (S10E). Alternatively, as shown in FIG. 9, when the structuring step (S20) is started (S20S), the process first proceeds to the user discrimination step (S11), then the interpersonal appropriateness step (S12), and finally structuring is performed in the structuring step (S29) and the structuring step (S20) is ended (S20E).

In the interpersonal appropriateness step (S12), it is possible to respond to each person's speaking style and terminology habits, allowing for more accurate input and structuring.

As shown in FIG. 3C, the input unit 1 includes a user discrimination unit 11 and an interpersonal appropriateness adjustment unit 12, but it goes without saying that the user identification unit 11 and the interpersonal appropriateness adjustment unit 12 may be provided in a place other than the input unit 11.

The recording and organizing device in this embodiment is any of the above-mentioned recording and organizing devices characterized by having an interpersonal appropriateness adjustment unit in addition to the user identification unit.

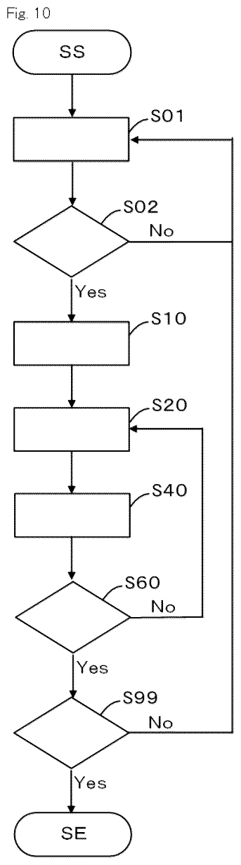

FIG. 10 shows the configuration of a recording and organizing method in an embodiment of the present invention.

In this embodiment, after the presentation step (S40) step, there is a confirmation step (S60) for accepting corrections.

What people say is not always grammatically correct, and the subject is often substituted with a pronoun and not explicitly stated, or in Japanese, the subject is often omitted. For this reason, it is inaccurate as information to simply recording voice, etc. as it is, and it is often difficult to utilize it as it is.

In the embodiments described above, accurate information is recorded by structured recording, but in this embodiment, a structured record is further presented to the user in a confirmation step (S60). If the information is not correct, the user re-states the correct information to restructure the information. This makes it possible to record more accurate and reliable information.

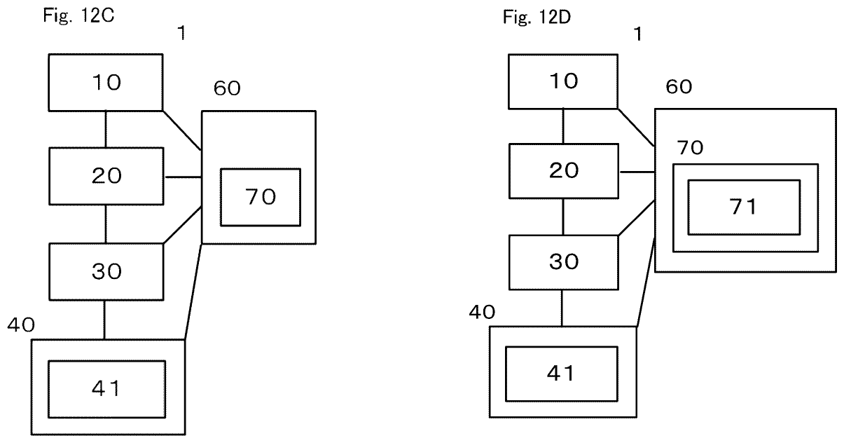

As shown in FIG. 12A, the recording and organizing device 1 includes a correction reception unit 41 within the presentation unit 40. It goes without saying that the modification reception unit 41 may be provided at a location other than the presentation unit 40. In this figure, a comparison unit 30, which will be described later, and a dictionary 70, which will be described later, are included in the control unit 60, but these are not essential configurations.

The recording and organizing device in this embodiment is any of the recording and organizing devices described above, characterized by having a presentation receiving unit that accepts corrections after the presentation by the presentation unit.

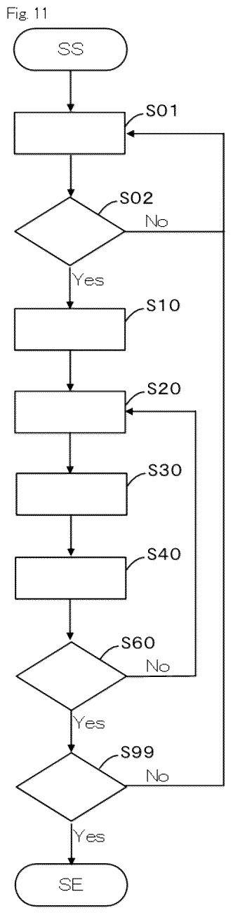

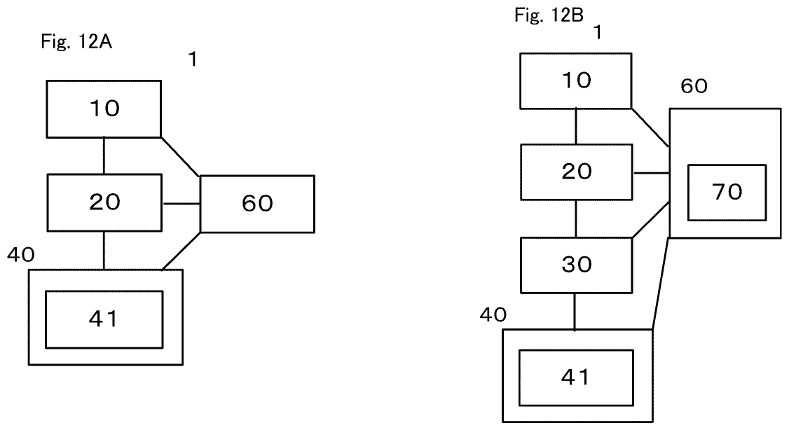

FIG. 11 shows a recording and organizing method in an embodiment of the present invention. FIG. 12B shows a recording and organizing device 1 in an embodiment of the present invention. In this embodiment, the recording and organizing device 1 includes a comparing unit 30.

In this embodiment, a comparison step (S30) is provided after the structuring step (S20). In the comparison step (S30), a comparison result is created by comparing the structured record with other information with reference to other information.

Other information refers to information other than the structured record input immediately before and structured in the structuring step (S20), which is currently being considered. Specific examples of other information include information already recorded in internal or external databases, such as past databases, material information, idea information, and similar case information. In the comparison step (S30), if other information is not structured in advance, the comparison becomes easier by structuring the other information. In this case, the comparison step (S30) may also include a structuring step. Furthermore, the search results themselves may be structured as appropriate.

In this embodiment, the structured record is a schedule, and the schedule with date and time information is compared with the past database that has already been input. This allows the user to check whether there are any other plans scheduled for the same time slot. You can also check to see if the same schedule is duplicated.

In the presentation step (S40), at least a part of the comparison results is presented.

In one embodiment, the structured record is material information, and in the comparison step (S30), internal or external databases can be referenced to check whether there are materials that meet the conditions or similar materials. This makes it possible to eliminate unnecessary research and development and make efficient use of in-house resources.

In one embodiment, the structured record is an ideation technique, and in the comparison step (S30), it is possible to refer to an internal or external database and compare it with similar technical information. This makes it possible to understand whether there are any ideas that have already been conceived, or what similar ideas exist, including differences.

In one embodiment, the structured record is similar case information, and in the comparison step (S30), an in-hospital or external database can be referred to and compared with similar case information. For example, by creating a structured record of age, gender, height, weight, body temperature, blood pressure, pulse rate, symptoms, history, etc., the user can check whether there are any similar cases that have occurred in the past, and what to do in that case. It is possible to understand whether certain measures have been taken, including the differences.

With this configuration, it is possible to support medical responses outside of specialized fields.

In either example, it is important to note that the comparison results clearly indicate the points of similarities or differences between the structured record and the target of comparison, and the comparison results are not simply a list of similar examples. This is because, if a list of similar examples is enumerated, it becomes necessary to look at each individual example, and examination or diagnosis are interrupted. However, if the structure clearly shows the points of similarities or differences, even in the middle of creative activities such as research and development or diagnosis, it is possible to concentrate on the points of similarities or differences by repeatedly obtaining the desired information without the need for tedious work or time, and creative activities such as research and development and diagnosis can be carried out smoothly. In this way, this configuration is more suitable for actual research and development, diagnosis, etc., which are being studied repeatedly. Furthermore, since the device which makes the structured records, clearly indicates which points match and which points differ from each other to the user, it becomes possible to modify the structured records themselves, such that recording accuracy can be improved.

The recording and organizing device in this embodiment is any of the above-mentioned recording and organizing devices having a comparison unit that creates a comparison result by comparing the structured record with reference to other information after the structuring, and the presentation unit presents at least a part of the comparison results.

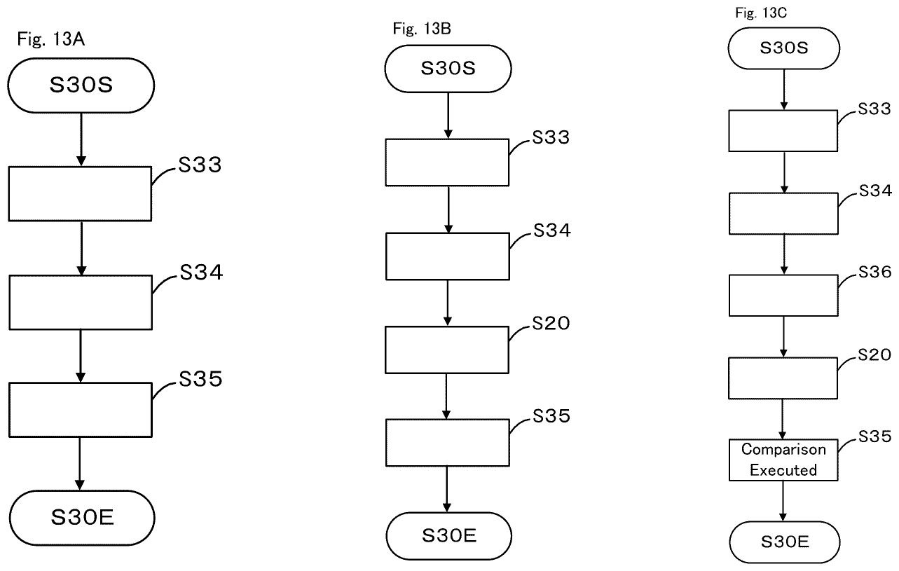

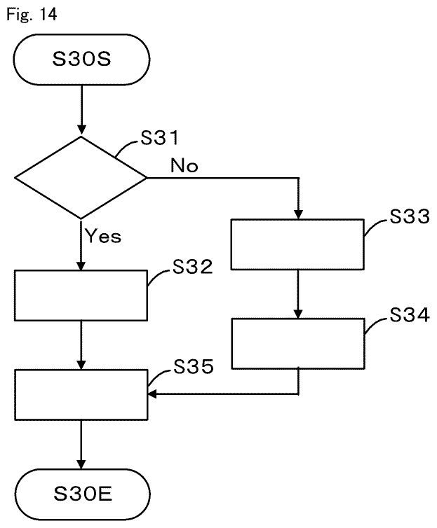

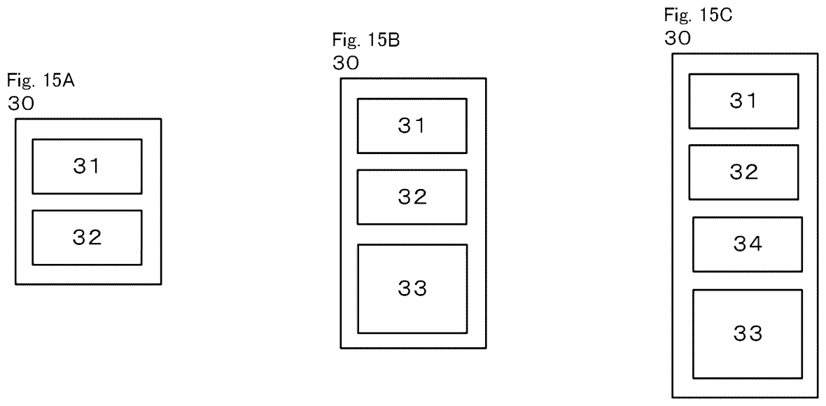

FIGS. 13 and 14 each illustrate a recording and organizing method in an embodiment of the present invention. FIG. 15 shows a recording and organizing device 1 in one embodiment of the present invention.

The comparison step (S30) includes a search step (S33) for searching for information regarding structured records, and a search result recording step (S34) for recording search result information that is the search result.

Specifically, as shown in A of FIG. 13, when entering the comparison step (S30) and proceeding to the start of comparison (S30S), first, in the search step (S33), the structured record to be searched is searched using internal databases and external databases. Next, in a search result recording step (S34), similar information found as a result of the search is recorded in an information recording device such as a hard disk or memory. Subsequently, in a comparison implementation step (S35), the structured record is compared with the information recorded in the search result record, and then the comparison is ended (S30E).

The recording and organizing device in the present embodiment is any of the recording and organizing devices described above wherein the comparison unit has a search unit that searches for information regarding the structured record, and a search result recording unit that records search result information that is the search result.

As shown in FIG. 15, the comparison unit 30 has a search result recording unit 32. The search result recording unit may be provided at a location other than the comparison unit, for example, a data storage area may be utilized.

In one embodiment, in the comparison step, when comparing with reference to other information, the retrieved similar information may be structured. The structuring is in the same format as the structured record, in which the comment of the user input in the input step are applied to a predetermined structure in the structuring unit.

Specifically, the comparison step further includes a structuring step (S20) after the search result recording step (S34) to structure the search result information. In other words, as shown in FIG. 13B, when the comparison step (S30) is started and the comparison begins, first, in the search step (S33), the structured record to be searched is searched for using the internal database or external database, etc. Next, in a search result recording step (S34), similar information found as a result of the search is recorded in an information recording device such as a hard disk or memory. Then, in a structuring step (S20), similar information is structured. Subsequently, in a comparison execution step (S35), the structured record is compared with the information recorded in the search result recording step (S34) and further structured in the structuring step (S20).

With this configuration, the user's comments and other information are structured in the same way and compared in the same format. Therefore, the accuracy of extraction and the accuracy of difference comparison are improved.

The recording and organizing device in this embodiment is any of the recording and organizing devices described above, wherein the comparison unit includes a comparison target structuring unit that structures the search result information. As shown in FIG. 15B, the comparison unit 30 includes a comparison target structuring unit 33.

In one embodiment, in the comparison step, when comparison is executed by referring to other information, the top of the retrieved similar information may be structured. The high-ranking similar information refers to, for example, about 10 to 100 high-ranking documents extracted in a patent search, and the information of documents that have conventionally been viewed visually. The higher rank document refers to a document with a high degree of similarity.

Specifically, the comparison step further includes, after the search result recording step (S34), a higher ranking extraction step (S36) for extracting a part of the search result information. In other words, as shown in FIG. 13C, when the process starts the comparison step (S30) and the comparison begins, first, in the search step (S33), the structured record to be searched is searched using the internal database or external database. Next, in a search result recording step (S34), similar information found as a result of the search is recorded in an information recording device such as a hard disk or memory. Then, in the higher order extraction step (S36), the higher order similar information with a higher degree of similarity is extracted, and in the structuring step (S20), the higher order similar information is structured. Subsequently, in a comparison execution step (S35), the structured record is compared with the information recorded in the search result recording step (S34) and further structured in the structuring step (S20).

The recording and organizing device according to the present embodiment is any of the recording and organizing devices described above, wherein the comparison unit includes a higher order extraction unit that extracts a part of the search result information and a comparison target structuring unit that structures a part of the search result information. As shown in FIG. 15C, the comparison unit 30 includes a higher order extraction unit 34 and a comparison target structuring unit 33.

It is possible to automatically determine the number of cases, which previously had to be done by the user visually, and notify the comparison results, allowing the user to proceed smoothly without stopping the work in progress or interrupting the work. I can do it. Furthermore, since all similar information is not structured at the time of search, but is limited to the top-ranking pieces of similar information, the overall processing speed is less affected and efficient processing is possible.

As shown in FIG. 14, the comparison step (S30) may further include a search range determination step (S31).

Specifically, when the process starts the comparison step (S30) and moving to the start of comparison (S30S), first, in the search range determination step (S31), whether the search range for the structured record under consideration is included in the rage of the previous search or not is checked. If the search has not been performed before then, it is determined that the information is not included in the previous search range because there is no information on the previous search range.

For example, if a user is searching for a car with an aluminum body and an accelerator on the handle, if cars with an accelerator on the handle were searched for in the previous search range, it is determined that the current search range is included in the previous search range.

If the current search range is included, the process proceeds to a record reference step (S32), where records of search results that have already been performed are referred to, and information similar to the structured record under consideration is obtained. Then, the process advances to a comparison implementation step (S35).

If the current search range is not included, the process advances to a search step (S33), then to a search result recording step (S34), and then to a comparison implementation step (S35), and the comparison step ends (S30E).

As shown in FIG. 15A, the comparison unit 30 includes a search unit and a search result recording unit 32 that records search result information.

Since the recording and structuring device has the search range determination step (S31) or the search result recording unit, for example, when searching for the second time or later, it is possible to recognize what the previous search results were, and the search range from the second time onwards is the same as the previous search target. If it is included within the range, it is also possible to significantly shorten the search time.

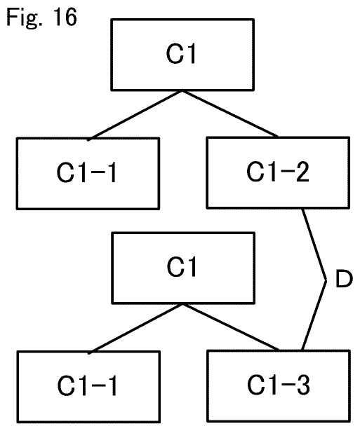

FIGS. 16, 17, and 18 show the configuration of a recording and organizing method in an embodiment of the present invention.

In this embodiment, the comparison result includes the difference (D) between the structured record and other information. In this example, the structured record is a schedule.

The recording and organizing device according to the present embodiment is any of the recording and organizing devices described above, wherein the comparison unit outputs a comparison result including a difference (D) between the structured record and the other information.

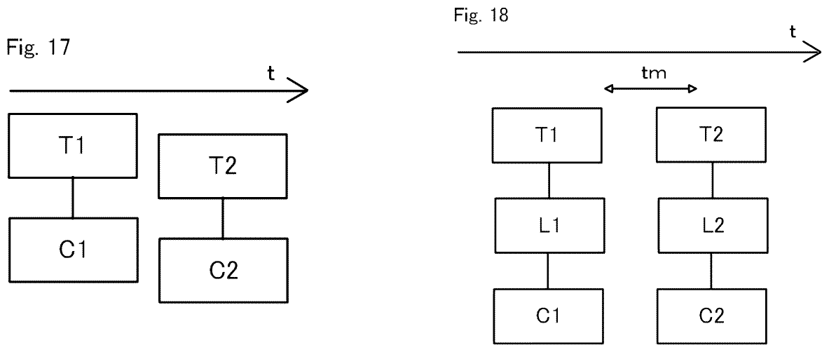

As shown in FIG. 17, overlap in time (T1, T2), that is, date and time, can also be presented as a difference. This allows the user to be informed that the schedules overlap.

Furthermore, as shown in FIG. 18, a predetermined time width can be provided before and after the scheduled times (T1, T2), and when they are close, the difference can be presented to the user. In particular, when time and location are included as components, by estimating the travel time (tm) based on the location (L1, L2) and checking whether two schedules are separated by more than this travel time, the user can be notified that the schedules overlap since the schedules are close to each other.

In one embodiment, the structured record is material information or idea technology, and in the comparison step (S30), internal or external databases can be referred to and compared with similar material information, technical information, etc. This makes it possible to understand whether there are existing materials or technologies that have already been conceived, or what similar products exist, including differences. In particular, by presenting the differences, it becomes possible to examine only the differences while proceeding with manual work or the like, without having to take the trouble to look at the terminal screen and examine where the differences are, and the user can much more efficiently proceed examination of technical information.

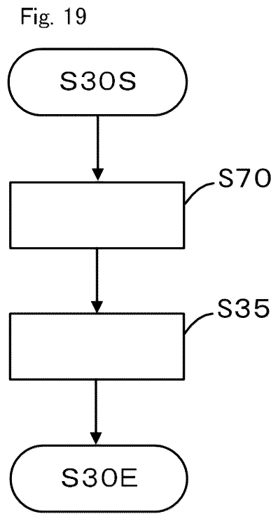

FIG. 19 shows a recording and organizing method in an embodiment of the present invention.

This embodiment includes a synonym reference step (S70) that refers to synonyms. A plurality of words and phrases can be stored as synonyms in a dictionary 70 or the like, which will be described later, and accurate information and comparison results can be shown based on the synonym information. Note that this dictionary 70 may be stored in the recording and organizing device 1, or may be an external dictionary. If the dictionary is external, the external dictionary can be referenced by communication via the control unit 60, for example.

For example, in material information, multiple names such as common names may be used for the same compound. For car manufacturers, vehicle body and body are the same. Also, in the medical field, the same disease may be described in multiple ways. By using synonymous information, it is possible to accurately understand synonymous words and present accurate information and comparison results.

In this embodiment, synonyms are referred to in the comparison step (S30), but they may also be referred to in each structuring step (S20) and comparison step (S30), and the synonym reference step (S70) may be performed in individual steps such as the structuring step (S20) and the comparison step (S30).

The recording and organizing device in this embodiment is any of the recording and organizing devices described above, which is characterized by referring to synonyms.

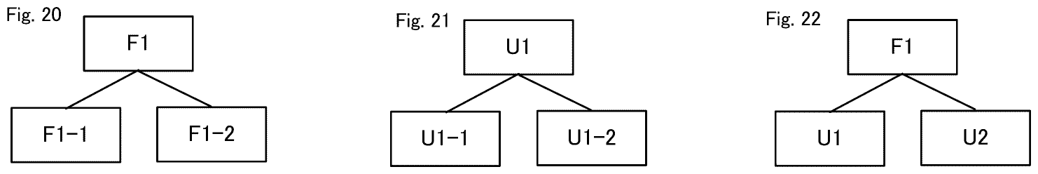

FIG. 20, FIG. 21, and FIG. 22 show a recording and organizing method in an embodiment of the present invention.

In this embodiment, a dictionary 70 is used which stores synonyms for each user (U) or field (F). The fields include schedule of work outside the company, schedule of work in the company, and private schedule. Alternatively, it may be in fields such as fashion, hobbies, technology, medical field, etc.

As shown in FIG. 20, fields can be classified into upper and lower concepts. Further, as shown in FIG. 21, by grouping the users, it is possible to classify the users in terms of upper and lower levels. Alternatively, as shown in FIG. 22, the users can be classified into users U1 and U2 who belong to a predetermined field F1.

For example, the word “body” has different terminology, such as the human body in apparel and the like, but the body of a car in car manufacturers, but a more accurate comparison can be made by referring to dictionary information for each user or field. be able to.

The recording and organizing device in this embodiment is any of the recording and organizing devices described above, having a dictionary that stores synonyms for each user or field.

As shown in FIG. 12C, the control unit 60 includes a dictionary 70. The dictionary may be configured to refer to something external to the recording device.

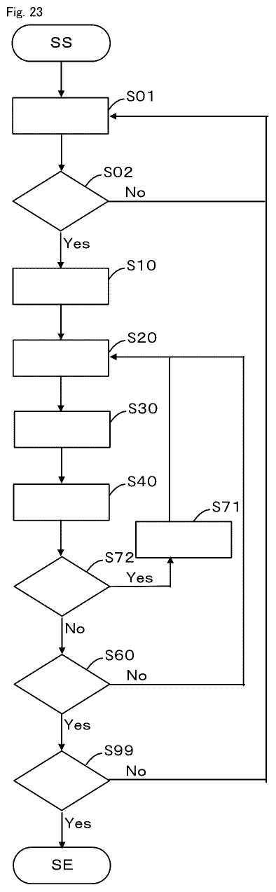

FIG. 23 shows a recording and organizing method in an embodiment of the present invention.

This embodiment includes a synonym correction step (S71) in which synonyms are corrected based on input from the user.

Specifically, after the presentation step (S40), the process proceeds to a synonym correction instruction step (S72).

For example, in a case where, in the comparison step (S30), the user who was reported in the recording and organizing method as “body and vehicle body are different” instructs a synonym such as “body and vehicle body are the same. Add it to the dictionary.”, it is interpreted that an instruction to correct a synonym has been given in the synonym correction instruction step (S72). The process then proceeds to a synonym correction step (S71), where it is recorded in the dictionary 70 or the like that the words “body” and “vehicle body” are synonymous. Thereafter, the process proceeds to the structuring step (S20) and the comparison step (S30) again, and a comparison result based on the corrected synonym information is presented in the presentation step (S40). In this way, the synonym information can be made more accurate based on the feedback from the user, and more accurate comparison results can be shown to the user.

The recording and organizing device in this embodiment is any of the recording and organizing devices described above, having a synonym correction unit that corrects the synonym based on input from the user. As shown in FIG. 12D, the dictionary 70 includes a synonym correction unit 71. The synonym correction unit may be located somewhere other than within the dictionary.

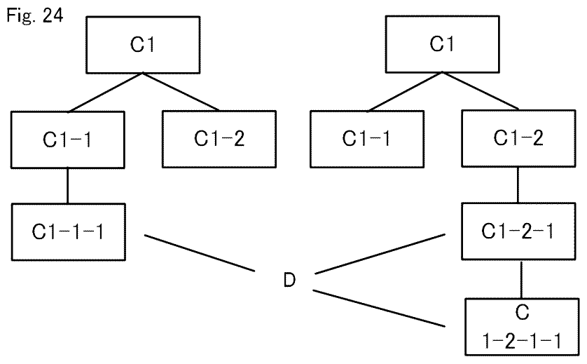

FIG. 24 shows the upper-lower relationship of concept (C) among the structures used in the recording and organization method in one embodiment of the present invention.

In this embodiment, concept data indicating the relationship between the upper and lower ranks of the concept (C) is referred to, and the comparison result includes the upper and lower ranks of the concept.

As a result, when considering the body of a car, for example, even if the body is made of the same metal, it is more clearly specified as a sub-concept as an aluminum body. In other words, it becomes more specific and as a result, more accurate comparison can be shown, making technical considerations smoother.

The recording and organizing device in this embodiment is any of the above-mentioned recording and organizing devices, characterized in that the comparison result includes the upper and lower ranks of the concept (C), and the comparison result includes the upper and lower ranks of the concept (C). It is.

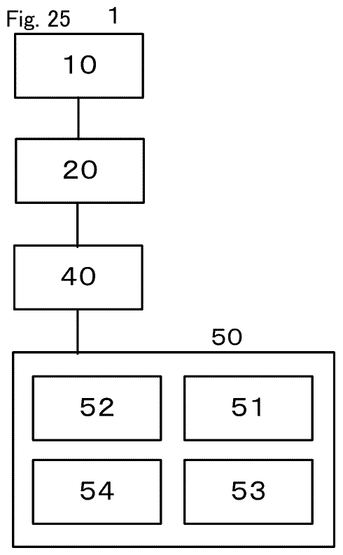

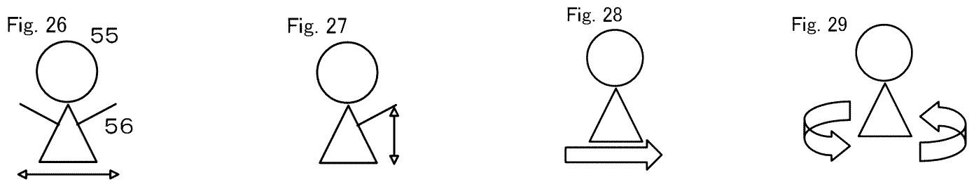

FIG. 25 shows the configuration of the recording and organizing device 1 in one embodiment of the present invention. FIG. 26, FIG. 27, FIG. 28, and FIG. 29 show the movement of the movement unit 50 in one embodiment of the present invention.

As shown in FIG. 25, in this embodiment, the recording and organizing device 1 further includes a movement unit 50. The movement unit 50 includes a movement power supply unit 51, an movement control unit 52, an arm drive unit 53, and a main body movement unit 54. The movement power supply unit 51 is connected to the movement control unit 52, the arm drive unit 53, and the main body movement unit 54 and supplies power thereto. The movement control unit 52 is connected to the arm drive unit 53 and the main body movement unit 54 and controls their respective movements. The arm driving unit 53 and the main body movement unit 54 drive the arm 56 and the main body 55, respectively.

The presentation unit 40 presents the size, speed, etc. by the rotation of the arm 56 and the main body 55, blinking, etc., other than presenting by voice or text information, through the movement of the movement unit 50.

In the example shown in FIG. 26, a humanoid device 55 with a body 55 shows its size by spreading its two arms 56. In other case, it indicates that the schedule, or appointment, is free and not booked with other events.

In the example shown in FIG. 27, the humanoid device moves the arm 56 up and down to indicate height, vertical movement, speed of vertical movement, etc.

In the example shown in FIG. 28, the humanoid device moves along with the main body 55 to indicate the direction and speed of movement.

In the example shown in FIG. 29, the humanoid device rotates together with the main body 55, thereby indicating the direction and speed of rotation.

The recording and organizing device according to the present embodiment is any of the recording and organizing devices described above, characterized in that it has an movement unit, and the movement unit executes presentation by a method other than audio or textual information.

In addition to the movement by the movement unit, it also includes the presentation unit presenting audio or text information.

One embodiment is a recording and organization program that executes each of the steps described above.

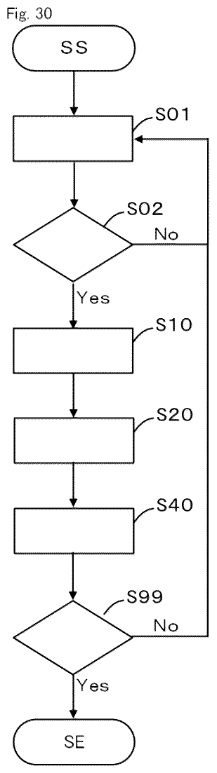

FIG. 30 shows an example of the configuration of the recording and organizing program. Since the explanation of each step is the same as that in FIG. 1, the explanation will be omitted. It goes without saying that other steps and configurations described above may be added.

One embodiment is a program for making the recording and organizing device 1 described above function as any of the recording and organizing devices 1 described above.

The diagrams are the same as the diagrams explaining each step described above, so the illustrations are omitted. It goes without saying that other steps and configurations described above may be added.

In one embodiment, it is a recording and organizing program for making a computer execute each of the steps described above, and is operated by an instruction from a CPU that executes a program expanded from a nonvolatile memory onto a RAM.

One embodiment is a recording and organization program for making the input unit 10, the structuring unit 20, the recording unit included in the control unit 60, and the presentation unit 40 function as each unit of the recording and organizing device 1 described above.

One embodiment is a recording and organization program for making the input unit 10, the structuring unit 20, the recording unit included in the control unit 60, the presentation unit 40, and the movement unit 50 function as each unit of the recording and organizing device 1 described above.

In one embodiment, it is a recording medium on which these programs are recorded.

It goes without saying that the present invention is not limited to the above embodiments, and includes various embodiments without departing from the spirit of the present invention.

For example, the order of each step may be altered or a plurality of steps may be provided within the scope of the spirit of the present application.

### INDUSTRIAL APPLICABILITY

The present invention provides a recording and organizing program, a recording and organizing method, and a recording and organizing device that organize and record voice records and the like as accurate information.

In addition, the present invention enables creative activities such as research and development, diagnosis, etc. to be carried out smoothly by repeatedly obtaining desired information without requiring complicated work or time, and the present invention provides a recording and organizing program, a recording and organizing method, and a recording and organizing device that are more suited to the field of diagnosis and diagnosis.

### EXPLANATION OF REFERENCE NUMERALS

1 Recording and organizing device
10 Input unit
11 User identification unit in input unit
12 Interpersonal appropriateness unit
20 Structuring unit
30 Comparison unit
31 Search unit
32 Search result recording unit
33 Comparison target structuring unit
34 Upper extraction unit
40 Presentation unit
41 Correction reception unit
50 Operating unit
51 Operating power supply unit
52 Operation control unit
53 Arm drive unit
54 Main body moving unit
55 Main body
56 Arm
60 Control unit
61 CPU
62 Program storage area
63 Data storage area
70 Dictionary
71 Synonym correction unit

1: A recording and organizing method configured to structure and record an input item, the method comprising:
an input step configured to input a user's comment through an input unit,
a structuring step configured to
make, in a structuring unit, a structured record by applying the user's comment input in the input step to a predetermined structure and
store the structured record in a recording unit, and,
a presentation step configured to present, to the user, at least a part of the structured record by a presentation unit, wherein
the structure has a tree structure composed of a plurality of hierarchies, and
the recording and organizing method further comprises:
a comparing step configured to create a comparison result by comparing the structured record with reference to other information, after the structuring step, wherein,
in the presentation step, at least a part of the comparison results is configured to be presented.

2: The recording and organizing method according to claim 1, wherein in the input step, text is input instead of the user's comment.

3: The recording and organizing method according to claim 1, wherein in the structuring step, the record is divided into time record and non-time record.

4-5. (canceled)

6: The recording and organizing method according to claim 1, further comprising a confirmation step of accepting corrections after the presentation step.

7. (canceled)

8: The recording and organizing method according to claim 1, wherein the comparing step comparing:
a searching step configured to search for information regarding the structured record, and
a search result recording step configured to record a search result information, the search result is a search result.

9: The recording and organizing method according to claim 8, wherein the comparing step further comprises the structuring step after the search result recording step to structure the search result information.

10: The recording and organizing method according to claim 8, comprising, after the search result recording step:
a higher order extraction step configured to extract a part of the search result information, and,
the structuring step to structure the search result information.

11: The recording and organizing method according to claim 8, wherein the comparison result includes a difference between the structured record and the other information.

12: The recording and organizing method according to claim 1, wherein the comparison result includes the superiority and inferiority of concepts by referring to concept data indicating the relationship between superiority and inferiority of concepts.

13: The recording and organizing method according to claim 1, further comprising a dictionary reference step configured to refer to synonyms.

14: The recording and organizing method according to claim 13, further comprising a dictionary storing a synonym for each user or for each field.

15: The recording and organizing method according to claim 14, further comprising a synonym modification step configured to modify the synonym based on input from the user.

16: The recording and organizing method according to claim 1, characterized in that the presentation is performed by a method other than audio or textual information through the movement of the movement unit.

17: The recording and organizing device comprising the input unit, the structuring unit, the recording unit, and the presentation unit, and configured to execute each step according to claim 1.

18: The recording and organizing device comprising the movement unit and being configured to execute each step according to claim 16.

19: A recording and organizing program configured to make the input unit, the structuring unit, the recording unit, and the presentation unit to function as each unit of the recording and organization device according to claim 17.

20: A recording and organizing program configured to make the input unit, the structuring unit, the recording unit, the presentation unit, and the operation unit to function as each unit of the recording and organization device according to claim 18.

21: The recording medium on which the recording and organizing program according to claim 19 is recorded.
